(19) United States
(12) Patent Application Publication
(10) Pub. No.: US 2018/0184269 A1
(43) Pub. Date: Jun. 28, 2018

(54) Autonomous Mesh Enabled Mobile Drone Hive

(71) Applicant: Flyspan System, Inc., Irvine, CA (US)

(72) Inventors: Brock Christoval, Irvine, CA (US); Vincent John Capobianco, Jr., Laguna Niguel, CA (US); Basilio Delmar Bena, Fontana, CA (US); Akash Chudasama, Glendora, CA (US)

(73) Assignee: Flyspan System, Inc., Irvine, CA (US)

(21) Appl. No.: 15/289,204

(22) Filed: Oct. 9, 2016

Related U.S. Application Data
(60) Provisional application No. 62/239,284, filed on Oct. 9, 2015.

(51) Int. Cl. H04W 4/40; H04B 7/0413; H04B 1/00; H04B 1/713

(52) U.S. Cl. CPC H04W 4/40; H04B 7/0413; H04W 84/18; H04B 1/713; H04B 1/0003

(57) ABSTRACT

The present invention discloses a wireless mobile ad-hoc network utilizing MIMO technology for data transmission to provide beyond line-of-sight communication. The invention discloses a wireless mobile ad-hoc network of one or more drone devices and one or more ground mobile vehicles, where each of the one or more drone device and the ground vehicle act as a node in the wireless mobile ad-hoc network and each node comprises multiple antenna for transmitting and receiving the data and communicates with other nodes through MIMO technology. Further, the present invention provides a comprehensive vehicle system to deploy, assess, and maintain the drones.

### CROSS-REFERENCE TO RELATED APPLICATION

This application claims benefit to U.S. Provisional Patent Application No. 62/239,284 filed Oct. 9, 2015, the disclosures of which are hereby incorporated by reference in their entirety.

### FIELD OF THE INVENTION

The present invention relates to a wireless mobile ad-hoc network of unmanned aerial vehicle and ground vehicle, and more particularly, to a wireless mobile ad-hoc network utilizing multiple-input multiple-output (MIMO) technology for transmission of data.

### BACKGROUND

Wireless network uses wireless data connections for connecting network nodes. Wireless networking is a method by which homes, telecommunications networks and enterprise installations avoid the costly process of introducing cables into a building or as a connection between various equipment locations. Mobile wireless telecommunications networks are generally implemented and administered using radio communication. Mobile Wireless network proves useful in accessing computing and communication services even when the nodes are moving.

The mobile wireless networks are of various types: infrastructure based networks, wireless LANs and Ad-hoc network. The infrastructure based networks utilizes traditional cellular system and base station infrastructure. The wireless LAN includes Infrared (IrDA) or radio links. The advantage of wireless LAN is that they are flexible within the reception areas; there may be possibility of creating ad-hoc network and less bandwidth consumption as compared to the wired network. The ad-hoc networks do not need backbone infrastructure support and are easy to deploy. These types of ad-hoc network are useful when infrastructure is either not available, impractical or is expensive.

Currently, the ground vehicles or aerial vehicle utilizes mobile ad-hoc network technology for communication purposes. However, the problem arises, when the network nodes are not in line-of-sight, thus hampering the transmission of information. The present invention overcomes this problem by providing a mesh network of aerial vehicles (drones) and ground vehicles. The mesh network is able to send data to and fro from the ground vehicles where an object would have blocked the line-of-sight of communication. Furthermore, the present invention provides a comprehensive vehicle system to deploy, assess, and maintain the drones.

### SUMMARY

In a first aspect of the present invention, a system for communicating data is provided. The system comprising: a wireless mobile ad-hoc network of one or more drone devices and one or more ground mobile vehicles, each of the one or more drone devices and the one or more ground mobile vehicles act as a node in the wireless mobile ad-hoc network; wherein each node comprises multiple antenna for transmitting and receiving the data and communicates with other nodes through multiple-input multiple-output (MIMO) technology. Each of the drone devices is communicatively linked to the corresponding ground mobile vehicle. Each node transmits, receives or relays information using a radio frequency. The wireless mobile ad-hoc network utilizes a software defined radio that allows frequency agile communications and jam resistance via spread spectrum frequency hopping. The software defined radio change the frequency of operation to avoid the loss of communication. The ground mobile vehicles are self-driven using autonomous driving system. The data transmission will be in real time.

In a second aspect of the present invention, an analytics platform for a wireless mobile ad-hoc network is provided. The analytics platform comprising: an unmanned aerial vehicle having one or more sensors to collect data and process the collected data; a ground mobile vehicle having an antenna for receiving and transmitting data to the unmanned aerial vehicle, said ground mobile vehicle comprising a communication station with one or more computer interfaces to process and display the data from the unmanned aerial vehicle. In the analytics platform, the one or more computer interfaces display the data related to analytical overlay of the unmanned aerial vehicle. The ground mobile vehicle includes on-board analytics computational storage directed to the storage and processing of the information coming from unmanned aerial vehicle. The analytics platform further comprising a cloud based computing system for storage and processing large data sets that can be used to store, compute, and transmit data wirelessly to the ground mobile vehicle.

In a third aspect of the present invention, a mobile vehicle for conducting the deployment and retrieval of an unmanned aerial vehicle is provided. The mobile vehicle and the unmanned aerial vehicle are the nodes of a wireless mobile ad-hoc network. The mobile vehicle comprising: a cabin having a maintenance station for placement of unmanned aerial vehicle platforms and supporting equipment; a liftable slab placed adjacent to the maintenance station, the liftable slab is connected to an elevator lift system used to deploy the unmanned aerial vehicle from the maintenance station level to the roof of the mobile vehicle. The roof of the mobile vehicle have a weatherproof lid to allow an access point for the deployment of the unmanned aerial vehicle from the maintenance station level on to the roof of the mobile vehicle. The roof of the mobile vehicle further comprises one or more charging pads for charging the unmanned aerial vehicle.

In a fourth aspect of the present invention, a method for communicating data. The method comprising: creating a wireless mobile ad-hoc network of one or more drone devices and one or more ground mobile vehicles, each of the one or more drone devices and the one or more ground mobile vehicles act as a node in the wireless mobile ad-hoc network; wherein each node comprises multiple antenna for transmitting and receiving the data and communicates with other nodes through multiple-input multiple-output (MIMO) technology. Each of the drone devices is communicatively linked to the corresponding ground mobile vehicle. Each node transmits, receives or relays information using a radio frequency. The mobile ad-hoc network utilizes a software defined radio that allows frequency agile communications and jam resistance via spread spectrum frequency hopping. The software defined radio changes the frequency of operation to avoid the loss of communication.

### BRIEF DESCRIPTION OF DRAWINGS

The preferred embodiment of the invention will hereinafter be described in conjunction with the appended drawings provided to illustrate and not to limit the scope of the invention, wherein like designation denote like element and in which:

FIG. 1 illustrates a mesh network of a plurality of drone devices and a plurality of mobile vehicles in accordance with an embodiment of the present invention.

FIG. 2 shows external features of a mobile vehicle serving as a base station for a drone device in accordance with an embodiment of the present invention.

FIG. 3 shows representation of data transmission between a mobile vehicle and the linked drone device in accordance with an embodiment of the present invention.

FIG. 4 illustrates data transmission between two or more mobile vehicles in accordance with an embodiment of the present invention.

FIG. 5 illustrates a communication station in the mobile vehicle in accordance with an embodiment of present invention.

FIG. 6 shows internal portion of the mobile vehicle having a maintenance station in accordance with an embodiment of the present invention.

FIG. 7 illustrates a drone launch and retrieval system in accordance with an embodiment of the present invention.

FIG. 8 shows an external view of the mobile vehicle launching a drone in accordance with an embodiment of the present invention.

FIG. 9 represents an autonomous mobile vehicle driving on public roadways demonstrating its sensing and self-governing operations in accordance with an embodiment of the present invention.

FIG. 10 represents a method for communication among plurality of drone devices and a plurality of mobile vehicles in a mesh network in accordance with an embodiment of the present invention.

### DETAILED DESCRIPTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention is directed to a mesh network comprising unmanned aerial vehicle in communication with manned and unmanned ground vehicle, submersible vehicles or underground vehicles for digital transmission of data. The use of unmanned aerial vehicle in the wireless communication provides wireless connectivity for devices without infrastructure coverage. Each of the unmanned aerial vehicle, ground vehicle, submersible vehicle and underground vehicle act as a node in the mesh network. Each node can transmit, receive or relay information. The unmanned aerial vehicle can be a drone system or a quadcopter/multirotor system.

The on-demand wireless systems with low-altitude aerial vehicles are in general faster to deploy, more flexibly re-configured, and have better communication channels due to the presence of short range line-of-sight (LoS) links. The system utilizes mobile ad-hoc network protocols (MANET) to form the mesh network topology in order to provide beyond line-of-sight communication.

The communication in the mesh network can be used to handle a number of tasks such as real time data transfer of surrounding, surveillance etc. The data collected by the drone device is communicated to a mobile ground or aerial vehicle which also acts as a node in the mesh network.

In another aspect, a mobile vehicle for conducting various operations related to drone or unmanned aerial vehicle is provided. The various operations on drone or unmanned aerial vehicle may include drone deployment system, maintenance station, viewing station and the cloud based data distribution. The mobile vehicle may include a compact van, a cargo size van, a large body coach vehicle, a caravan or any compatible vehicle that can acts as a communication node.

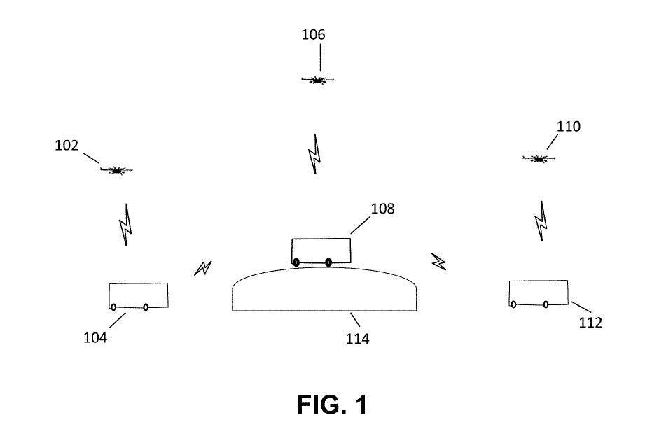

FIG. 1 illustrates a mesh network of a plurality of drone devices and a plurality of mobile vehicles in accordance with an embodiment of the present invention. Each of the plurality of drone devices in the mesh network is in communication with the corresponding mobile vehicle. The configuration represented in FIG. 1 shows a first drone device 102 linked with a first mobile vehicle 104, a second drone device 106 linked with a second mobile vehicle 108 and a third drone device 110 linked with a third mobile vehicle 112. Each of the first drone device 102, the second drone device 106, the third drone device 110, the first mobile vehicle 104, the second mobile vehicle 108 and the third mobile vehicle 112 forms a wireless mobile ad-hoc network (MANET), wherein each component act as the node in the mobile ad-hoc network (MANET). The first mobile vehicle 104, the second mobile vehicle 108 and the third mobile vehicle 112 are in communication with each other through a communication link. The mesh network topology provides beyond the line-of-sight communications where a hill or other object 114 would have otherwise block the communication link. Every node in the mesh network is a radio transceiver, capable of transmitting, receiving, buffering and forwarding data over a radio communication channel.

The data links are used to support communication between the drone device and the mobile vehicles. The data link supports the following communication modes: 1) drone to drone wireless communication; 2) drone to mobile vehicle communication; 3) mobile vehicle to mobile vehicle communication. The capacity of the data link may vary from several kbps to few Gbps. The data links can reuse the existing band assigned for a particular application. For instance, for cellular coverage, LTE band can be assigned for the data link. These data-links can be used to transport data such as video, sensor platform data, air/ground vehicle command and control, to or from drones.

The wireless mobile ad-hoc network of the plurality of drone devices and the mobile vehicles is self-forming and self-healing. Any of the drone device and the linked mobile vehicle can join or leave the mobile ad-hoc network (MANET) at any time. When a new node joins the MANET, the network will continuously adapt its topology as the nodes move in relation to one another. The mobile ad-hoc network (MANET) has a decentralized architecture in that there are no central master hub radios required to administer the control of the network, and communications between other nodes will be there even if one or mode nodes are lost.

In an embodiment, the mesh network exhibit adaptive routing by determining the relay path when a stream of data is to be transmitted between a pair of drone device and/or the mobile vehicles.

In another embodiment of the present invention, the mesh network uses Multiple Input Multiple Output (MIMO) technology for exchanging data. Each of the nodes in the mesh network has multiple active antennas for transmitting and receiving data. The MIMO enables each node of the mesh network to transmit and receive multiple data signals through multipath propagation on the same radio channel at the same time, thereby increasing the data rate and link range. In Multiple Input Multiple Output (MIMO) technique, when a packet is transmitted into a channel, it is transmitted on more than one antenna and when it comes out of the channel, it is received on multiple antennas. This facilitates beyond-line-of-sight communications and data transmissions. Each node can transmit, receive or relay information.

In an embodiment of the present invention, the mesh network topology uses a software defined radio (SDR) that allows for frequency agile communications and jam resistance via spread spectrum frequency hopping. Upon detection of jamming or interference, the SDR can dynamically change the frequency of operation to avoid the loss of communication. With the increment in the number of communications nodes in the mesh network, the geographical span potential of the network is also increases. Strategic placement of nodes allows for communications over, under or around physical barriers such as an object 114 as well as allows for data path redundancies to increase network robustness.

The MANET mesh network topology provides beyond line-of-sight communication. The mesh network will be able to send data to or from the first mobile vehicle 104 and the third mobile vehicle 112, where a hill or other object 114 would otherwise block line-of-sight communications. To provide beyond line-of-sight communication, the second mobile vehicle 108 or the second drone 106 acts as a relay node. The first mobile vehicle 104, the third mobile vehicle 112, the first drone device 102 and the third drone device 110 can communicate with each other through a relay communication link provided by the second mobile vehicle 108 and the second drone device 106 in the mesh network.

Strategic placement or autonomous arrangement of different nodes of the mesh network allows for the establishment of the effective communications perimeter. Data transfer between from each node, whether ground or aerial, individual is achieved using the MANET protocols which will relay data as many “hops” as necessary to get to the intended destination.

The robust mobile ad-hoc network (MANET) allows for inter-nodal communications to facilitate autonomous data collection and transmittal. This data can be either passive where it is simply relayed back to the collection point or active where vehicle either ground or air maneuvering or placement can be determined or adjusted based on the real-time feedback of aerial and/or ground sensors.

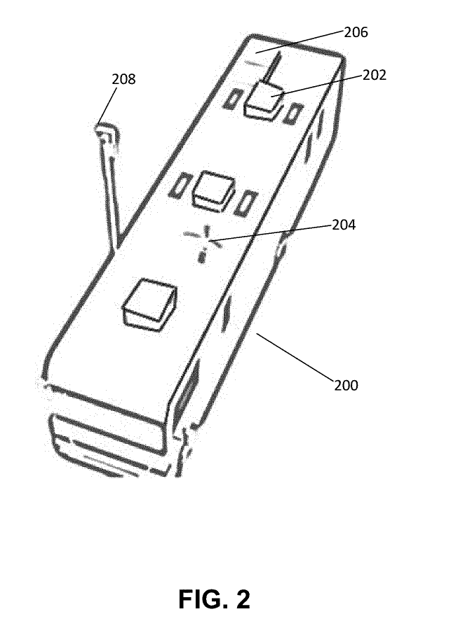

FIG. 2 shows external features of a mobile vehicle serving as a base station for a drone device in accordance with an embodiment of the present invention. The mobile vehicle 200 is having a drone lift deployment system, a maintenance station, a viewing station, and a cloud based data distribution and monitoring station. The mobile vehicle is a fully enclosed transportation vehicle in various sizes including a commercially available compact van, commercially available cargo size van, and commercially available large body coach vehicle.

At the external surface of the mobile vehicle 200, there are one or more charging pads 202 located on the roof of the mobile vehicle 200, an external communication relay 204 that is used to establish communication link with navigation satellite, other mobile vehicles and remote station. A launch and recovery window 206 is present on the roof of the mobile vehicle 200, such that when a drone device has to be deployed from the mobile vehicle, the launch and recovery window 206 opens for providing passage for the drone deployment. In normal use, the launch and recovery window 206 of the mobile vehicle 200 remains in closed position. The mobile vehicle 200 also has a radio communication 208 device which establishes a communication link with the linked drone device. The data feed from the drone device are received through the radio communication device and fed into the communication station of the mobile vehicle 200. The data streams are then analyzed and results are then displayed at various monitors present in the communication station of the mobile vehicle 200.

The one or more charging pads 202 comprise coupling system which generates a field that cause current to flow in the drone device. A plurality of drone device can make electrical contact with one charging pad. The charging pad 202 receives power supply from a power generation system or a battery array. When a drone device lands on the charging pad 202, the sensor present on the charging pad detects the drone device, and the charging pads get electrically coupled with the drone device. When the drone device gets completely charged, the sensor terminates the electrical coupling between the charging pad and the drone device.

The charging pad 202 provides automated remote charging and rapid deployments to a drone without human intervention.

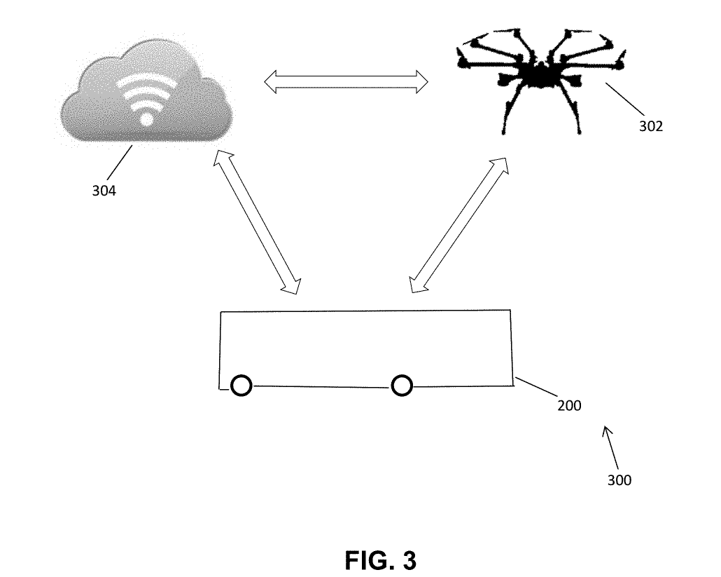

FIG. 3 shows representation of data transmission between a mobile vehicle and the linked drone device in accordance with an embodiment of the present invention. The drone device 302 comprises processing and communication units that enable the drone to navigate by controlling the directionality and spatial position of the drone device 302. The communication unit in the drone receives spatial and directional information from the mobile vehicle 200. The position information may be associated with the current position or position information obtained for the mobile vehicle 200 or the charging pads 202 etc.

The drone device 302 may also comprise a control unit for controlling functionalities associated with the drone device. The control unit may include a power module, a processor and a radio module. One or more data capturing devices are installed on the drone device 302. The one or more data capturing devices capture the data and transmit the stream of data to the mobile vehicle 200. The captured data and other information are stored in a memory unit linked with the processor. The drone device 302 also comprises a power source for providing sufficient power to conduct various control and operations for controlling the drone and drone subsystems; and a GNSS navigation unit for providing navigation facility. One or more landing sensors may also be present in the drone device 302 for imparting smooth landing and take-off functionality to the drone device 302. The one or more landing sensors also aid in charging of the drone device 302 at the charging pad 202 of the mobile vehicle 200.

The communication unit in the drone device has a radio module which helps in establishing communication with other nodes in the mesh network. The drone device 302 also communicates the stream of data to a server 304 through a communication link, and the server 304 in turn communicates the data to the mobile vehicle 200. There is a bi-directional communication link between transmit/receive antenna of the radio module of the drone device 302, radio communication device on the mobile vehicle 200, transceiver on other nodes and the server 304. The transmission of data between the nodes of the mesh network is through MIMO mode, such that data are transmitted by M antennas and received by n antennas. An array of M×N representing the multi-antenna propagation channel is estimated and data are transmitted according to a transmission mode selected from one or more multi-antenna mode.

The mobile vehicle 200 consists of a user interface in the form of a collection of computer interfaces with the optical and supplemental data readouts from the drone device 302 on display. Supplemental displays exhibit the analytical overlays of the drone device operation. The mobile vehicle 200 includes an on-board analytics computational storage dedicated to the drone device information storage and processing. The mobile vehicle 200 includes a transmission antenna mounted on the side or top of the mobile vehicle for providing the drone device 302 an extended range of operation. Also, an additional antenna is mounted onboard the roof of the mobile vehicle 200 for data retrieval to and from the server 304. The mobile vehicle 200 provides transmission of the drone device's operational data to one or more mobile vehicles, to the server, and to the drone devices. Further, the drone device utilizes multi camera operations or on-board sensing equipment throughout the operation and sends the operational data to either the mobile vehicle 200 or the server 304. The server 304 can be an established cloud based computing system that is utilized for information storage or processing of large data sets and can be used to store, compute, and transmit data wirelessly to the mobile vehicle's on-board computing system.

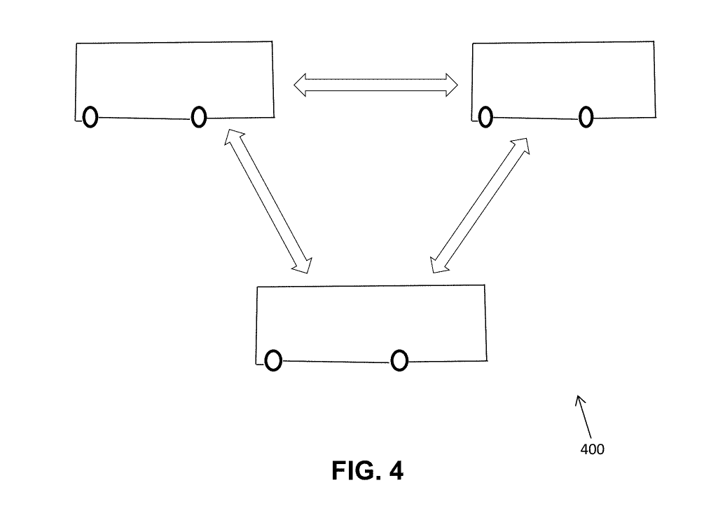

FIG. 4 illustrates data transmission between two or more mobile vehicles in accordance with an embodiment of the present invention. Referring to FIG. 4, an illustration of a fleet of mobile vehicle that makes a wireless mobile ad-hoc network 400. In an embodiment, the communication between two or more mobile vehicle is through short range radio signals. The ad-hoc mesh network 400 is used to pass messages between the mobile vehicles in the fleet. When information is received from a drone device to its linked mobile vehicle, the mobile vehicle determines if the information is to be passed on to one or more nodes of the mesh network. If the message is not intended to be passed on, the process ends. If it is determined that the information has to be transmitted to other node, then the network topology is considered to determine the number of nodes that has to be act as a relay node for transmission of the information. If the destined node is not in line-of-sight with the originating node, then one or more other node will serve as relay node for transmission of the information.

When the MANET communication network is needed to deliver a message, the communication station of the sender node determines the most efficient and reliable route in the communication network based on the current stored topology. While determining the route, the reliability can be further improved by taking into consideration intended trajectories of other nodes into account. Once a route is determined, the sender mobile vehicle transmits the information to next available relay node, which then forwards the information to another relay node, until the information reaches the destination node. The communication between the nodes or the mobile vehicle happens through MIMO technology where M numbers of antennas are used to transmit information and N numbers of antennas are used to receive the information.

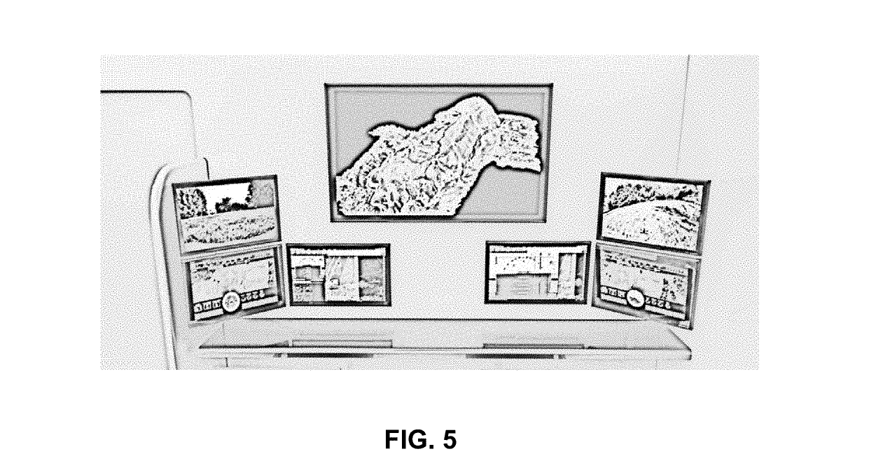

FIG. 5 illustrates a communication station in the mobile vehicle in accordance with an embodiment of present invention. The communication station in the mobile vehicle comprises a transceiver for receiving and sending data, an analytics module for analyzing the data and a displaying module for displaying the data and results. For instance, the monitors are used for GIS software and data stream. The analytical software is used for analysis and interpreting information received from the drone device. A monitor can be used for GIS mapping exported from the drone's analytical software or other picture stitching software, monitors and can depict drone's live footage.

The interface of the drone's analytical software represents a real-time situational awareness and full time analytics. The drone's analytical software provides data analytics related to the transmission of data over a cloud or an Internet Protocol (IP) to the mobile vehicle. The monitors or the interfaces placed can be used for drone's analytical software, data streaming etc. The GIS software or the drone's analytical software, onboard the drone device 302 conducts the analytics using the external communication relay 204 and sends the data to the server 304.

The communication station includes a user interface for presenting the optical and supplemental data readouts from the drone device 302 on display. Supplemental displays exhibit the analytical overlays of the drone device operation. The mobile vehicle 200 includes onboard analytics computational storage dedicated to the drone information storage and processing. The mobile vehicle 200 includes the communication relay 204, mounted on the side or top of the mobile vehicle 200, for extending the range of drone's operation. The communication relay 204 may be an antenna. Also, an additional antenna is mounted onboard the roof of the mobile vehicle 200 for data retrieval to and from the server 304. The mobile vehicle 200 provides transmission of the drone device's operational data to one or more mobile vehicles, to the server, and to the drone devices. Further, the drone device utilizes multi camera operations or on-board sensing equipment throughout the operation and sends the operational data to either the mobile vehicle 200 or the server 304. The server 304 can be an established cloud based computing system that is utilized for information storage or processing of large data sets and can be used to store, compute, and transmit data wirelessly to the mobile vehicle 200 and the drone device 302.

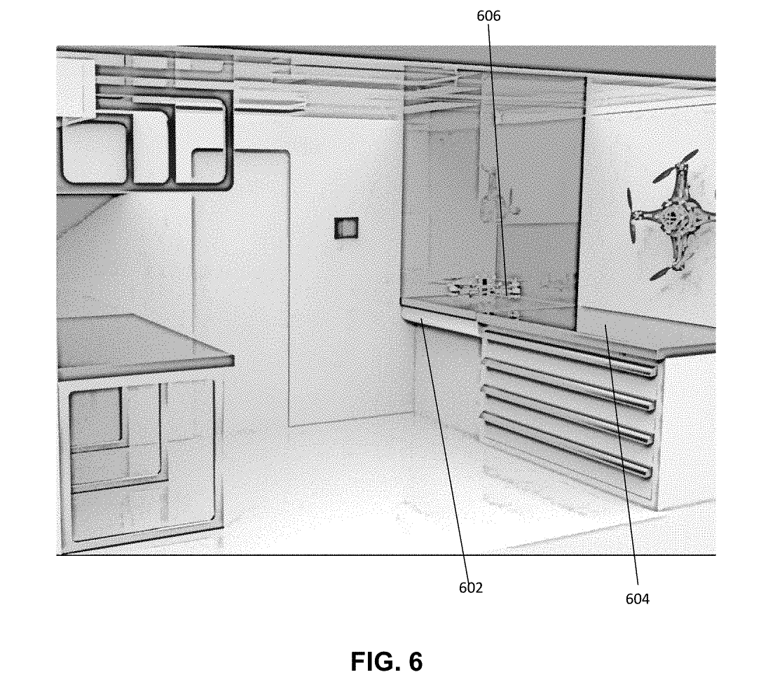

FIG. 6 shows internal portion of the mobile vehicle having a maintenance station in accordance with an embodiment of the present invention. The mobile vehicle 200 includes storage locations for placement of a drone platform and supporting equipment. The storage enclosures include commercially available door latch systems or racks located on the ceiling, walls or floor of the mobile vehicle 200. The maintenance station has a cabinet space 602, a working space 604 and a drone's lift platform 606. The maintenance station provides a support of routine maintenance on drone's operations and to employ rapid launching of the drone through the drone's lift platform 606 from the internal to external portion of the mobile vehicle 200. The cabinet space 602 is provided for securing the drone's lift platform 606 and for supporting equipment. The working space 604 is used for maintenance of the drone's lift platform 606. The working space 604 is designed to be placed adjacent to a lifting mechanism for drone's deployment. This co-location facilitates in the rapid internal to external deployment of the drone's lift platform 606. The drone's lift platform 606 conducts the internal to external deployment of drone technology.

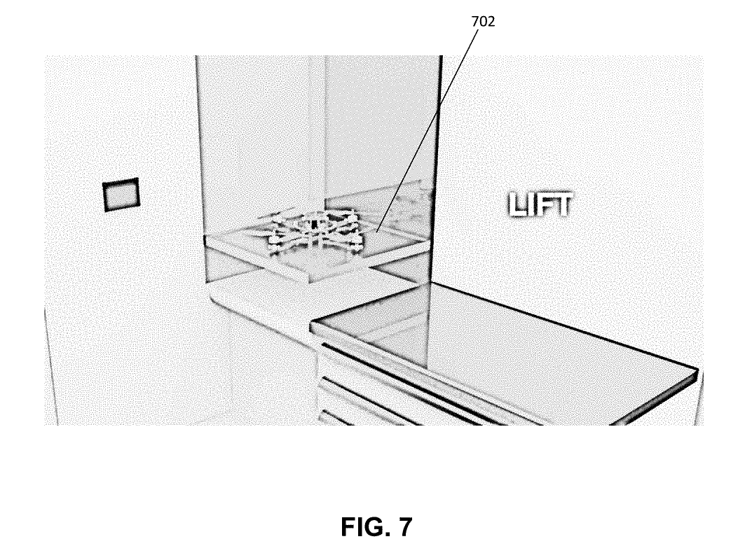

FIG. 7 illustrates a drone launch and retrieval system in accordance with an embodiment of the present invention. A portion of the maintenance station is used as the drone launch and retrieval system 702. After the routine maintenance of the drone has been completed, the drone is positioned on the launch and retrieval system 702 which is adjacent to the maintenance station. The drone launch and retrieval system 702 is designed to have a lift system placed at the bottom face of the slab of launch and retrieval system. When the drone is to be deployed from inside to the roof of the mobile vehicle 200, the lift system raises the slab from the level of maintenance desk to the roof of the mobile vehicle. The launch and recovery window 206 on the roof of the mobile vehicle 200 opens, when the launch and retrieval system 702 raises the drone to the roof of the mobile vehicle. The launch and recovery window has a weatherproof lid. The drone's lift platform works with the weatherproof closing lid on the roof of the mobile vehicle 200 to allow an access point for the drone from the internal to external portion or the external to internal portion of the vehicle. The drone's operation can begin once weatherproof lid is in the closed position. The weatherproof lid will be opened when there will be internal to external or external to internal launch of the drone.

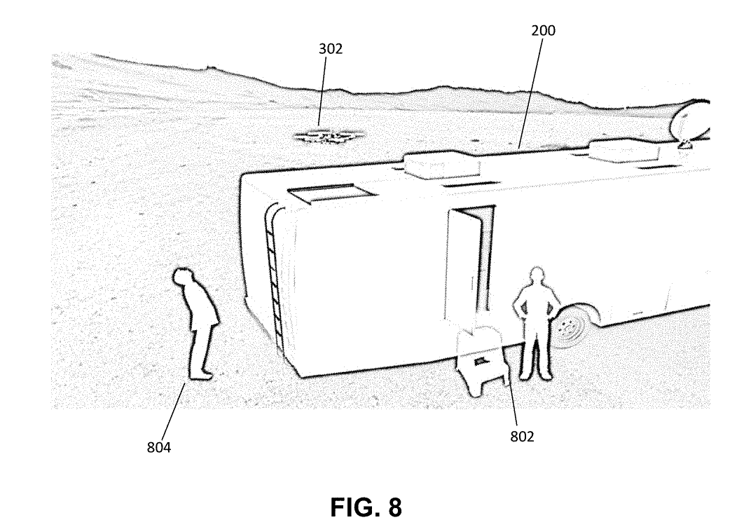

FIG. 8 shows an external view of the mobile vehicle launching a drone in accordance with an embodiment of the present invention. The pilot 802 is operating the drone device 302 coupled with the mobile vehicle 200. The pilot 802 and the observer 804 can also have handheld radio devices which can also act as a relay node in the mesh network.

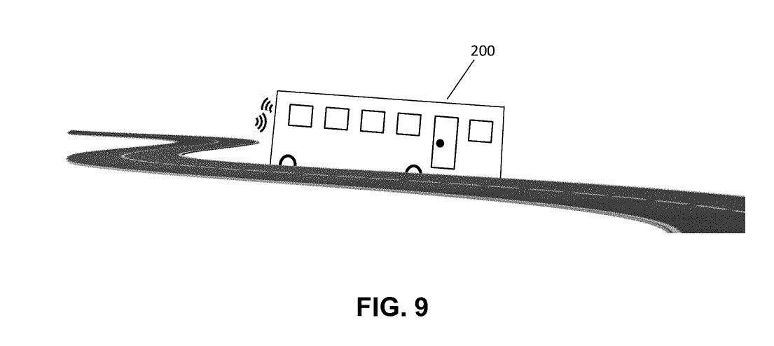

FIG. 9 represents an autonomous mobile vehicle driving on public roadways demonstrating its sensing and self-governing operations in accordance with an embodiment of the present invention. The mobile vehicle 200, which acts as a node in the mesh network, is configured to autonomous driving utilizing the conventional technology. The technology used for autonomous driving may include techniques such as Radar, Lidar, GPS, and computer vision. Sensors can be placed around the mobile vehicle 200 that will enable the autonomous capability to operate without a human intervention. The sensors will be utilized throughout the mobile vehicle 200 for providing an active sensory input and will be installed throughout the mobile vehicle 200 for allowing the mobile vehicle 200 to keep track of its position even when conditions change or when they enter uncharted environments.

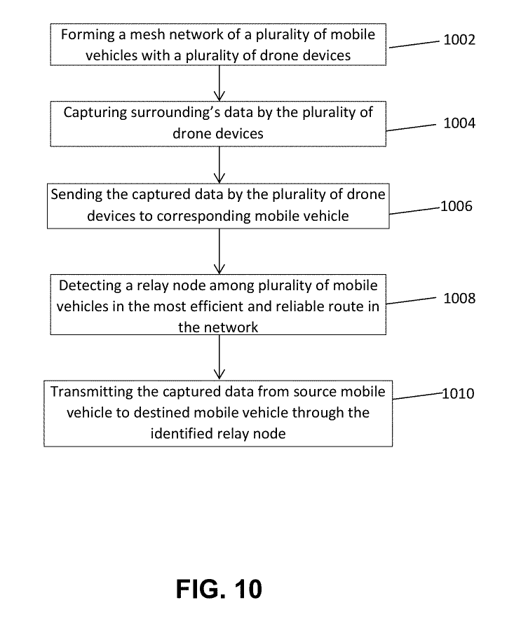

FIG. 10 represents a method for communication among plurality of drone devices and a plurality of mobile vehicles in a mesh network in accordance with an embodiment of the present invention. At step 1002, each of the plurality of drone devices in the mesh network is in communication with the corresponding mobile vehicle. The exemplary configuration represented in FIG. 1 shows a first drone device 102 linked with a first mobile vehicle 104, a second drone device 106 linked with a second mobile vehicle 108 and a third drone device 110 linked with a third mobile vehicle 112. Each of the first drone device 102, the second drone device 106, the third drone device 110, the first mobile vehicle 104, the second mobile vehicle 108 and the third mobile vehicle 112 forms a wireless mobile ad-hoc network (MANET), wherein each component act as the node in the MANET. Thereafter, the each of the plurality of drone devices captures surrounding's data at step 1004. After this, the captured data is transmitted, at step 1006, by the each of the plurality of drone devices to corresponding mobile vehicle through the communication link formed between them. At step 1008, detecting a relay node among plurality of mobile vehicles, which is the most efficient and reliable route in the communication network. Once a route is determined, the sender mobile vehicle transmits the information to next available relay node, which then forwards the information to another relay node, until the information reaches the destination node at step 1010. The communication between the nodes or the mobile vehicle happens through MIMO technology, where M numbers of antennas are used to transmit information and N numbers of antennas are used to receive the information. Referring to FIG. 1, the second mobile vehicle 108 is acting as a relay node between the first mobile vehicle 104 and the third mobile vehicle 112. The first mobile vehicle, the second mobile vehicle and the third mobile vehicle are in communication with each other through a communication link. The mesh network topology provides beyond the line-of-sight communications. Every node in the mesh network is a radio transceiver, capable of transmitting, receiving, buffering and forwarding data over a radio communication channel. There can be one or more relay nodes in the mesh network.

The mobile vehicle 200 consists of a user interface in the form of a collection of computer interfaces with the optical and supplemental data readouts from the drone device 302 on display. Supplemental displays exhibit the analytical overlays of the drone device operation. The mobile vehicle 200 includes an on-board analytics computational storage dedicated to the drone device information storage and processing. The mobile vehicle 200 includes a transmission antenna mounted on the side or top of the mobile vehicle for providing the drone device an extended range of operation. Also, an additional antenna is mounted onboard the roof of the mobile vehicle for data retrieval to and from the server 304. The mobile vehicle 200 provides transmission of the drone device's operational data to one or more mobile vehicles, to the server, and to the drone devices. Further, the drone device utilizes multi camera operations or on-board sensing equipment throughout the operation and sends the operational data to either the mobile vehicle or the server. The server can be an established cloud based computing system that is utilized for information storage or processing of large data sets and can be used to store, compute, and transmit data wirelessly to the mobile vehicle's on-board computing system.

Although the invention has been explained in relation to its preferred embodiment, it is to be understood that many other possible modifications and variations can be made without departing from the spirit and scope of the invention. Obvious changes, modifications, and substitutions may be made by those skilled in the art to achieve the same purpose the invention. The exemplary embodiments are merely examples and are not intended to limit the scope of the invention. It is intended that the present invention cover all other embodiments that are within the scope of the descriptions and their equivalents.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

1. A system for communicating data, the system comprising:
a wireless mobile ad-hoc network of one or more drone devices and one or more ground mobile vehicles, each of the one or more drone devices and the one or more ground mobile vehicles act as a node in the wireless mobile ad-hoc network;
wherein each node comprises multiple antenna for transmitting and receiving the data and communicates with other nodes through multiple-input multiple-output (MIMO) technology.

2. The system of claim 1, wherein each of the drone devices is communicatively linked to the corresponding ground mobile vehicle.

3. The system of claim 1, wherein each node transmits, receives or relays information using a radio frequency.

4. The system of claim 1, wherein the wireless mobile ad-hoc network utilizes a software defined radio that allows frequency agile communications and jam resistance via spread spectrum frequency hopping.

5. The system of claim 4, wherein the software defined radio change the frequency of operation to avoid the loss of communication.

6. The system of claim 1, wherein the ground mobile vehicles are self-driven using autonomous driving system.

7. The system of claim 1, wherein the data transmission will be in real time.

8. An analytics platform for a wireless mobile ad-hoc network, comprising:
an unmanned aerial vehicle having one or more sensors to collect data and process the collected data;
a ground mobile vehicle having an antenna for receiving and transmitting data to the unmanned aerial vehicle, said ground mobile vehicle comprising a communication station with one or more computer interfaces to process and display the data from the unmanned aerial vehicle.

9. The analytics platform of claim 8, wherein the one or more computer interfaces display the data related to analytical overlay of the unmanned aerial vehicle.

10. The analytics platform of claim 8, wherein the ground mobile vehicle includes on-board analytics computational storage directed to the storage and processing of the information coming from unmanned aerial vehicle.

11. The analytics platform of claim 8 further comprising a cloud based computing system for storage and processing large data sets that can be used to store, compute, and transmit data wirelessly to the ground mobile vehicle.

12. A mobile vehicle for conducting the deployment and retrieval of an unmanned aerial vehicle, wherein the mobile vehicle and the unmanned aerial vehicle are the nodes of a wireless mobile ad-hoc network, the mobile vehicle comprising:
a cabin having a maintenance station for placement of unmanned aerial vehicle platforms and supporting equipments;
a liftable slab placed adjacent to the maintenance station, the liftable slab is connected to an elevator lift system used to deploy the unmanned aerial vehicle from the maintenance station level to the roof of the mobile vehicle.

13. The mobile vehicle of claim 12, wherein the roof of the mobile vehicle have a weatherproof lid to allow an access point for the deployment of the unmanned aerial vehicle from the maintenance station level on to the roof of the mobile vehicle.

14. The mobile vehicle of claim 12, wherein the roof of the mobile vehicle further comprises one or more charging pads for charging the unmanned aerial vehicle.

15. A method for communicating data, the method comprising:
creating a wireless mobile ad-hoc network of one or more drone devices and one or more ground mobile vehicles, each of the one or more drone devices and the one or more ground mobile vehicles act as a node in the wireless mobile ad-hoc network;
wherein each node comprises multiple antenna for transmitting and receiving the data and communicates with other nodes through multiple-input multiple-output (MIMO) technology.

16. The method of claim 15, wherein each of the drone devices is communicatively linked to the corresponding ground mobile vehicle.

17. The method of claim 15, wherein each node transmits, receives or relays information using a radio frequency.

18. The method of claim 15, wherein the mobile ad-hoc network utilizes a software defined radio that allows frequency agile communications and jam resistance via spread spectrum frequency hopping.

19. The method of claim 18, wherein the software defined radio changes the frequency of operation to avoid the loss of communication.
